(19) United States
(12) Patent Application Publication
(10) Pub. No.: US 2019/0096244 A1
(43) Pub. Date: Mar. 28, 2019

(54) VEHICLE-TO-MANY-VEHICLE COMMUNICATION

(71) Applicant: Intel Corporation, Santa Clara, CA (US)

(72) Inventors: Palanivel Guruva Reddiar, Chandler, AZ (US); Barath Lakshmanan, Chandler, AZ (US); Farshad Akhbari, Chandler, AZ (US)

(21) Appl. No.: 15/714,530

(22) Filed: Sep. 25, 2017

(51) Int. Cl. G08G 1/09; H04N 19/17; H04N 19/164; G06K 9/00

(52) U.S. Cl. CPC G08G 1/092; H04N 19/17; H04N 19/164; G06K 9/00805; G06K 9/00818; G06K 9/00825; G06K 9/00711

(57) ABSTRACT

Methods and apparatus are described for vehicle-to-vehicle communication. Embodiments receive a data request from a remote vehicle for data not available to the remote vehicle. Visual data from a host vehicle responsive to the data request that includes the data not available to the remote vehicle is determined. The visual data is analyzed for objects to create metadata associated with the visual data. The visual data and the metadata are provided to the remote vehicle in response to the data request.

### TECHNICAL FIELD

Embodiments described herein relate generally to vehicle-to-vehicle communications. Embodiments may be implemented in hardware, software, or a mix of both hardware and software.

### BACKGROUND

Connected vehicles is a promising technology in the autonomous driving area. Vehicle-to-vehicle (V2V) communication between connected vehicles involve exchanging data between the vehicles. Video data from one or more cameras is one source of data in V2V communications and plays a major role in scenarios such as look ahead traffic. There is a trend to increase the camera resolution to detect objects at higher distances. The available wireless bandwidth to transmit the video data, however, is limited. Aggressive compression may be used to transmit high resolution video data over the limited available bandwidth. Aggressive compression, however, may introduce artifacts in the video data. These artifacts may affect the object detection and classification process at the remote vehicle, which would impact the detection/classification accuracy at the remote vehicle.

### BRIEF DESCRIPTION OF THE DRAWINGS

FIG. 1 illustrates a system architecture for V2V communication according to some embodiments.

FIG. 2 illustrates an image analysis architecture according to some embodiments.

FIG. 3 illustrates a traffic look ahead and overtake scenario according to some embodiments.

FIG. 4 illustrates a traffic jam scenario according to some embodiments.

FIG. 5 is a diagram of V2V communication according to some embodiments.

FIG. 6 is an example computing device that may be used in conjunction with the technologies described herein.

### DETAILED DESCRIPTION

Vehicles may use one or more cameras to capture visual data. The visual data may be analyzed to detect objects within the visual data. The vehicle may need visual data from areas that are inaccessible to the vehicle's camera. For example, a front vehicle that is ahead of the subject vehicle may block the subject vehicle's camera from areas in front of the front vehicle. In various embodiments, visual data from the front vehicle may be provided to the subject vehicle such that the look ahead data will be available to the subject vehicle. Prior to sending the visual data, the front vehicle may analyze the visual data to detect a region of interest that contains potential objects. Rather than sending the entire visual data, the region of interest may be cropped from the visual data. The cropped visual data may then be sent rather than the entire visual data. In an example, the region of interest may also be compressed at the front vehicle. In another example, the region of interest may be sub-sampled at the front vehicle. The region of interest, sub-sampling of the region of interest and compression helps to reduce the needed bandwidth used for V2V communication.

In various scenarios, visual data from one vehicle may be useful to many different vehicles. The vehicles registers themselves with the V2V infrastructure that may include a server such as a server in the cloud. The registered vehicles may be provided with a unique identifier. In an example, the server may receive requests for visual data from remote vehicles. The server may use the vehicle identifier along with the location information to determine the appropriate vehicle that contains the visual data that is not occluded by other vehicle's cameras and requests for visual data from the identified vehicle. The requested vehicle may provide the region of interest visual data to a server, such as a server in the cloud, which may be transmitted to the remote vehicles. Thus, multiple vehicles may receive useful visual data with the originating vehicle only uploading the visual data once.

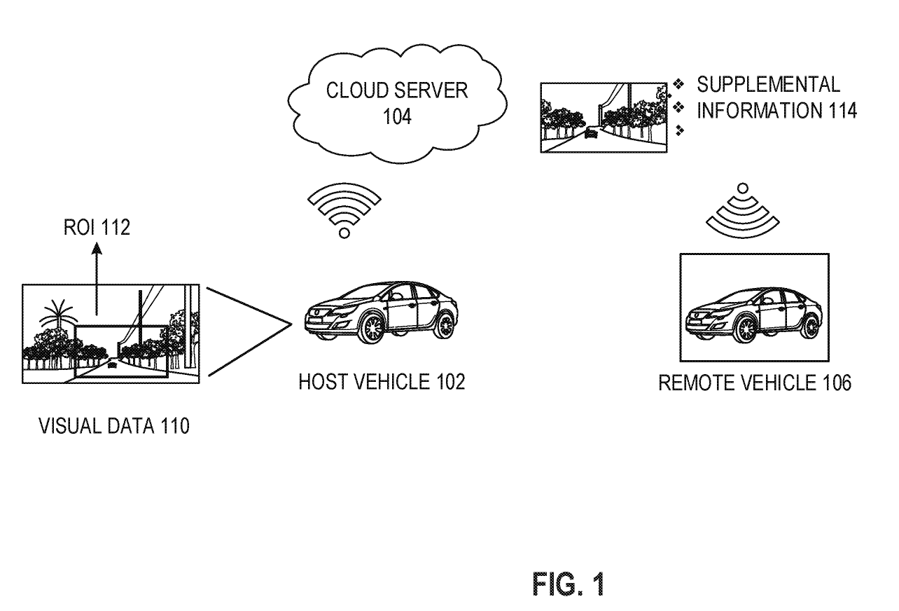

FIG. 1 illustrates a system architecture for V2V communication according to some embodiments. A host vehicle 102 captures visual data 110 using one or more cameras controlled by the host vehicle 102. The host vehicle 102 may analyze the visual data to identify the region of interest which may include one or more potential objects 112. In an example, ROI analysis is done using a deep learning network to analyze the contents of the visual data 110. The ROI 112 that encapsulates one (or) more potential objects may be cropped from the visual data 110. Either the visual data or the cropped ROI 112 may then be compressed. In an example, flexible macro block ordering (FMO) scheme may be used. The visual data/ROI 112 may then be sent to a remote server 104, such as a cloud server. The remote server 104 may then run an object identification analysis on the ROI 112 to generate supplemental information 114. The supplemental information 114 may include the number of objects within the ROI 112, the height/width of the objects, coordinates of objects, and sematic information depicting the scene within the ROI 112. This supplemental information 114 may be sent as meta data. In an example, the meta data is sent in the form of supplemental enhancement information (SEI). For example, SEI with the MPEG-4 codec may be used. Certain decoders may be able to decode and use this information.

FMO may be used after the isolation of foreground and the background in the visual data 110. In an example, using FMO, the data bandwidth assigned to the foreground portion of the visual data 110 may be greater than the data bandwidth assigned to the background portion. This allows the features of the foreground to be preserved that may help with the object identification process. In addition, the foreground portions 110 may be used to identify the ROI 112. The remote server 104 may also use FMO to compress the ROI 112 received from the host vehicle 102.

A remote vehicle 106 may request visual data from the remote server 104. In an example, the remote vehicle 106 requests data based upon the location/position of the remote vehicle 106. The remote server 104 may determine a vehicle located in front of the remote vehicle 106 that has relevant visual data. Relevant visual data may mean visual data from a vehicle that has some threshold distance in front of the vehicle before an object is detected. For example, a vehicle that has visual data with no object identified within 100, 200, 500, etc. feet in front of the vehicle. The position of the various vehicles may be used by the remote server 104 to determine which vehicle to use for the visual data. In an example, the remote server 104 may already have the relevant data. In another example, the remote server 104 may request the visual data from the relevant vehicle.

In an example, the remote server 104 determines the bandwidth between the remote server 104 and the remote vehicle 106. The type of visual data that may be transmitted using the available bandwidth is determined. In an example, the bandwidth allows the full resolution visual data to be sent to the remote vehicle 106. In another example, the bandwidth will not support transmitting the full resolution video of the ROI 112. In an example, the bandwidth is not enough for the full resolution video data to be transmitted. When this occurs, the ROI 121 may be compressed with FMO. In another example, the ROI 112 visual data is encoded with a reduced resolution such that the sub-sampled visual data may be transmitted using the available bandwidth. In another example, the sub-sampled visual data is compressed with FMO and then transmitted over the available bandwidth, such that the foreground portion is represented using higher number of bits than the background portion. The supplemental data 114 may also be transmitted to the remote vehicle 106.

The same use of sub-sampling and compression may be done at the host vehicle 102 to transmit the visual data 112 to the remote server 104. Thus, the available bandwidth is used to provide the best visual data that may be transmitted over the available bandwidth.

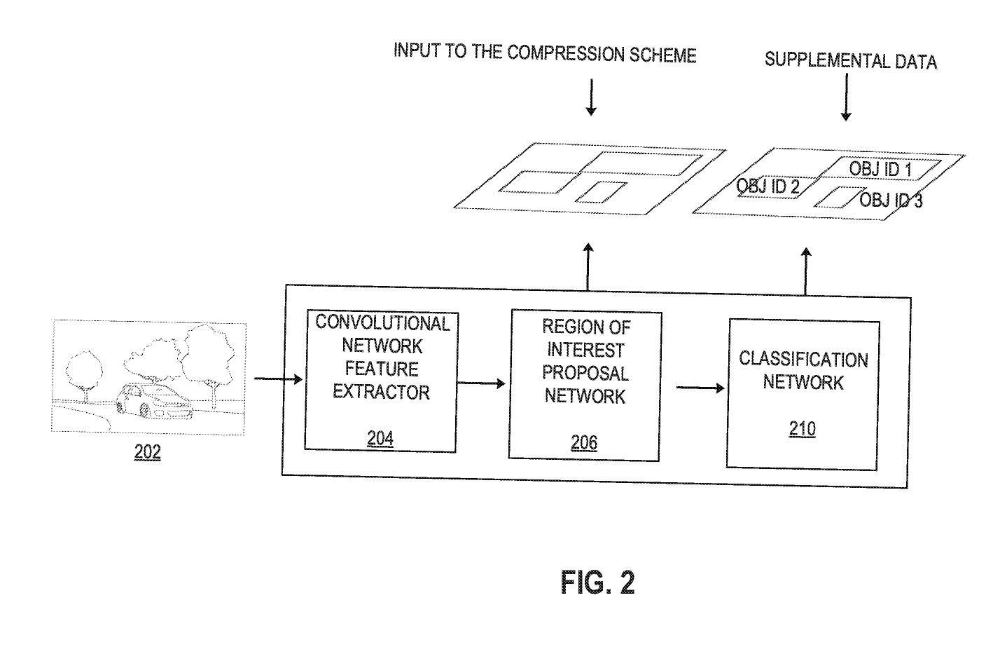

FIG. 2 illustrates an image analysis architecture according to some embodiments. In an example, the image analysis is done on the host vehicle to determine the ROIs that will be transmitted to the remote server. The host vehicle captures an image 202. The image 202 may be a frame from a video, a still image, etc. In an example a deep learning network analyzes the image 202 and may use feature maps to determine possible ROI that encapsulates the potential objects. For example, convolutional network feature extractor 204 may be used to identify various features within the image 202. The features may then be passed to a ROI proposal network 206 that identifies ROIs within the image 202. The ROIs may then be cropped out ROI from the image. The cropped ROI may then be compressed as described above. The cropped ROIs may also be passed to a classifier network 210 that identifies objects within the ROIs. Each object may be associated with an object identifier. The classifier network may determine road conditions within the ROI. For example, standing water, ice, debris, etc., may be classified. This information may be provided along with the compressed ROIs. Accordingly, the road condition information may also be provided to a remote vehicle that receives the ROI.

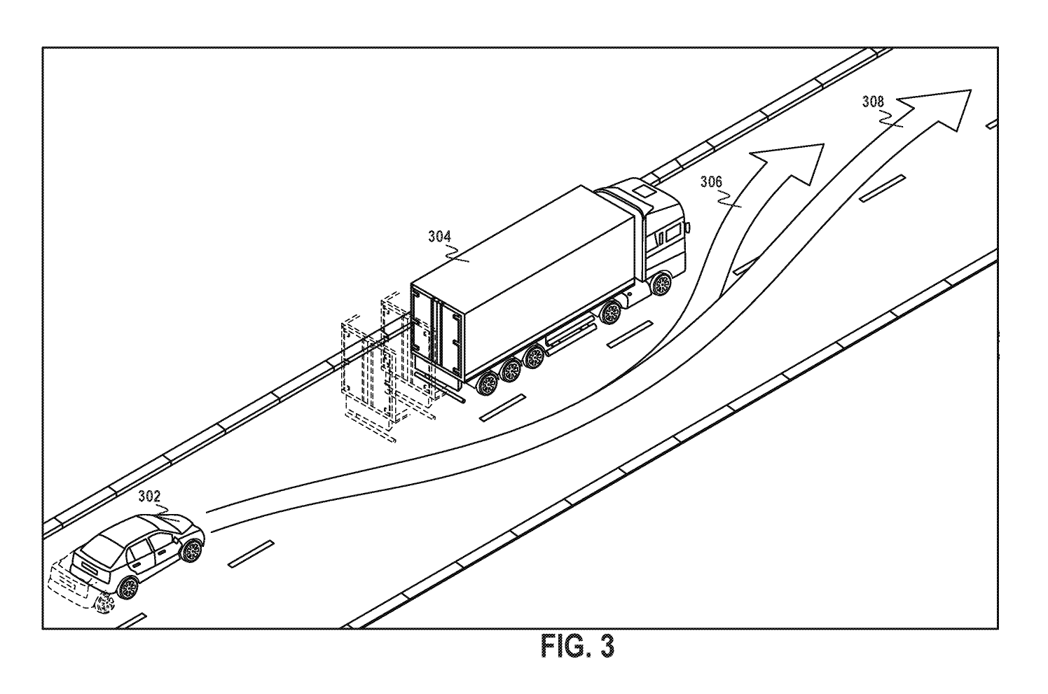

FIG. 3 illustrates a traffic look ahead and overtake scenario according to some embodiments. A vehicle 302 would like to pass a truck 304. The vehicle 302, however, is unable to gather visual data from in front of the truck 304. The visual data from the truck 304 may be made available to the vehicle 302. For example, the visual data may be the data from the front camera of the truck 304. Direct communication between the truck 304 and the vehicle 302 may be used, however, such communication may consume considerable power at the truck 304 when the same data is requested from multiple vehicles. As described above, the truck 304 may analyze visual data from one or more cameras on the truck 304. The truck 304 may analyze the visual data for an ROI. The ROI may be cropped from the visual data, compressed and sent to a remote server (not shown). The remote server may then send the cropped visual data to the vehicle 302. The vehicle 302 may then use the visual data from the truck 304 to determine which path 306 or 308 to use to overtake the truck 304.

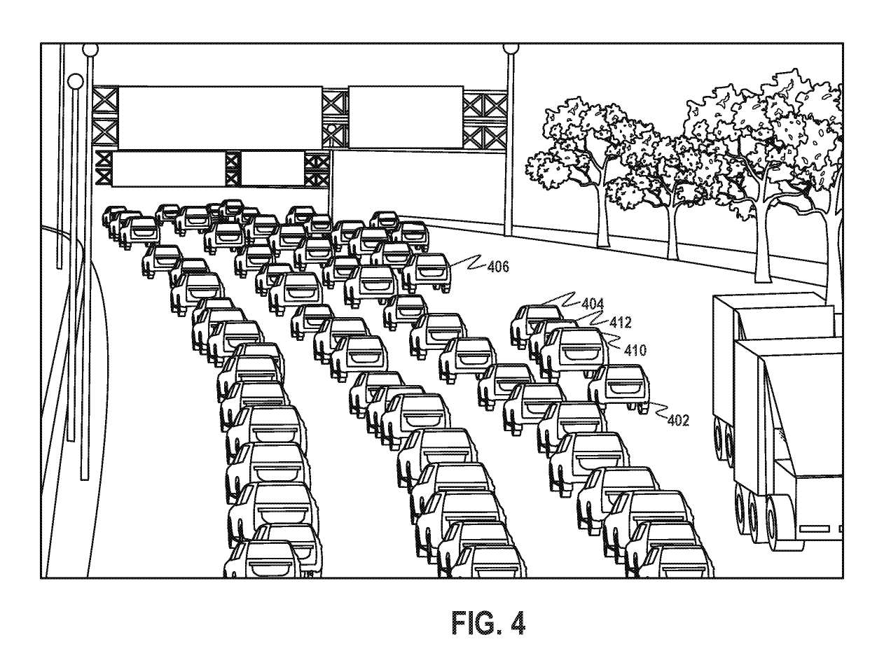

FIG. 4 illustrates a traffic jam scenario according to some embodiments. The traffic jam scenario illustrates the power consumption issue. If one vehicle transmitted its visual data to multiple nearby vehicles, that transmitting vehicle would consume a significant amount of power for these transmissions. For example, if vehicle 404 transmitted its visual data to nearby vehicles, such transmission would require significant power. As described above, providing visual data such as the raw video, encoded video, ROIs, or encoded ROIs, a single transmission to a remote server may be used to provide the visual data to multiple vehicles.

In an example, vehicles 402, 404, 406, 410, and 412 may provide visual data to a remote server (not shown). The vehicle 402 may request relevant visual data. Relevant visual data may mean visual data not available to the vehicle 402 but relevant for making driving decisions. For example, visual data from a vehicle located in front of the vehicle 402 that has an area immediately in front of the front vehicle that does not contain an obstacle may provide the visual data. In the illustrated example, this may be vehicle 404. The remote server may determine the visual data from the vehicle 404 should be used by looking for vehicles located in front of the vehicle 402. Location and position information from the various vehicles may be used to identify candidate vehicles located in front of the vehicle 402. In an example, the analysis has been done as soon as the visual data is received. In another example, the analysis is done on an as-needed basis.

In FIG. 4, vehicles 410, 412, 404, and 406 would be candidate vehicles for the vehicles 402. The visual data from the candidate vehicles may then be analyzed to determine a closest object to each candidate vehicle. The candidate vehicles may be analyzed in order to determine how close each candidate vehicle is to the vehicle 402. The closest candidate vehicle may be analyzed first until useful visual data is determined. For example, the visual data from vehicle 410 is analyzed and a free distance in front of the vehicle 410 is determined. The vehicle 412 is close enough such that the free distance (unobstructed distance) in front of the vehicle 410 is not adequate for visual analysis. The visual analysis may need a certain amount of free space in front a vehicle such that the visual analysis creates useful results and/or useful object identification. When the free space is not adequate, the next vehicle, e.g., 412, may be analyzed. This repeats until the vehicle 404 is found to have adequate free distance.

Visual data that has an object within a certain distance, e.g., 50, 100, 250, 500 feet, etc., may be ignored. In an example, the remote server analyzes the visual data from the candidate vehicles until a candidate vehicle has visual data without an object within the certain distance. For example, the vehicle 404 may have useful visual data since the closest obstacle is the vehicle 406 that is located more than the certain distance in front of the vehicle 404. The visual data from the vehicle 404 may also be provided to vehicles 410 and 412.

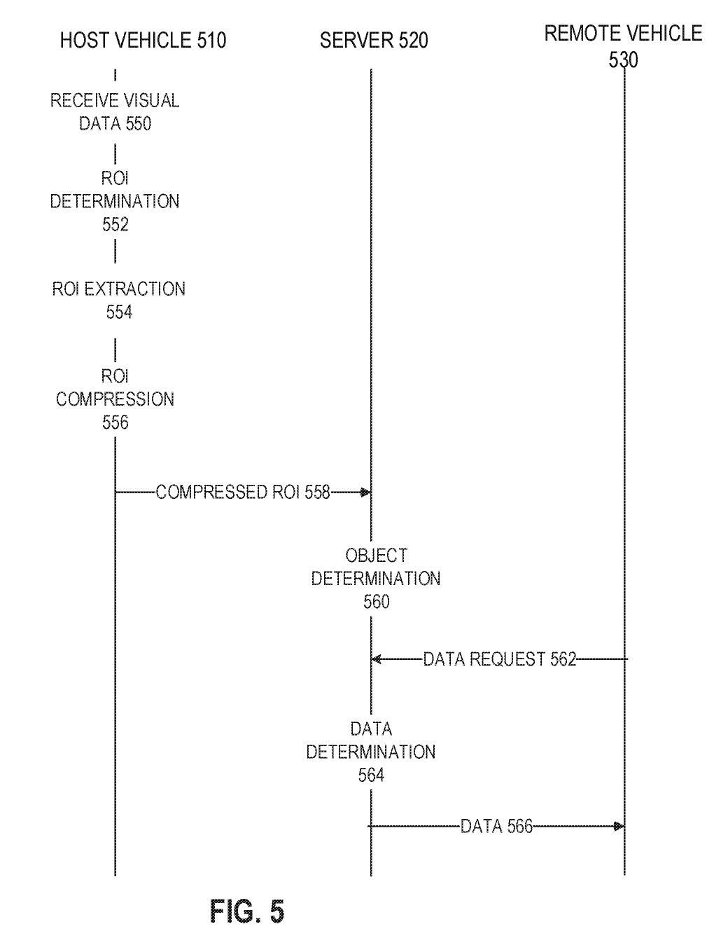

FIG. 5 is a diagram of V2V communication according to some embodiments. A host vehicle 510 receives visual data 550. For example, the host vehicle 510 may receive visual data from one or more cameras. As an example, a front facing camera located on or within the host vehicle 510 may provide visual data. In an example, the host vehicle 510 performs ROI determination 552. The ROI determination 552 identifies one or more areas within the visual data that contains one or more objects. A deep learning network may be used to identify the objects and the final ROI may encapsulate all the identified potential objects The ROI may be extracted/cropped from the visual data 554. The cropped ROI may then be compressed 556. In addition, before compression the cropped ROI may be sub-sampled with a reduced resolution. For example, the host vehicle 510 may determine the uplink bandwidth to the server 520 is such that the cropped ROI need to be compressed to be able to be transmitted over the available bandwidth within a certain period of time.

The compressed ROI may then be transmitted from the host vehicle 510 to the server 520 (operation 562). The server 520 may treat the compressed ROI as visual data. The server 520 may analyze the visual data to determine objects within the visual data 560. Information such as the type of object, size of the object, location of the object, etc., may be determined and stored along with the visual data. In an example, the information is stored as metadata along with the visual data. In an example, the objects detected may include infrastructure objects, traffic lights, traffic signs, etc.

A remote vehicle 530 may request visual data from the server 520. The request may include a vehicle identification and a location of the remote vehicle 530. The request may be for visual data that is not available to the remote vehicle 530 from the remote vehicle's cameras. The server 520 may then determine relevant visual data for the remote vehicle 564. Relevant visual data may include data that is not available to the remote vehicle 530. For example, visual data from vehicles located in front of the remote vehicle 530 may be identified as relevant visual data. In an example, visual data from vehicles in other lanes, such as adjacent lanes, may be identified as relevant visual data. In an example, visual data from vehicles traveling in the opposite direction of the remote vehicle 530 may be relevant visual data. For example, from FIG. 3, visual data from a vehicle traveling in the passing lane could be identified as relevant data for the passing vehicle. In an example, the server 520 may determine the visual data from a vehicle is not available. For example, the visual data may not have been received or the visual data may be determined to be stale based upon a time stamp. The server 520 may request that the host vehicle 510 has access to the desired visual data and request the visual data from the host vehicle 510. Once the visual data is received, the server 520 may then analyze the visual data for objects.

Once the relevant visual data is identified, the relevant visual data may be transmitted to the remote vehicle 530 (operation 566). The relevant visual data may include the objects identified in the visual data. For example, the metadata describing the identified objects may be transmitted as part or along with the visual data. In an example, the server 520 may determine the bandwidth available for transmission and determine the visual data should be re-encoded with a reduced resolution for faster transmission. In this example, the server 520 may re-encode the visual data prior to transmission.

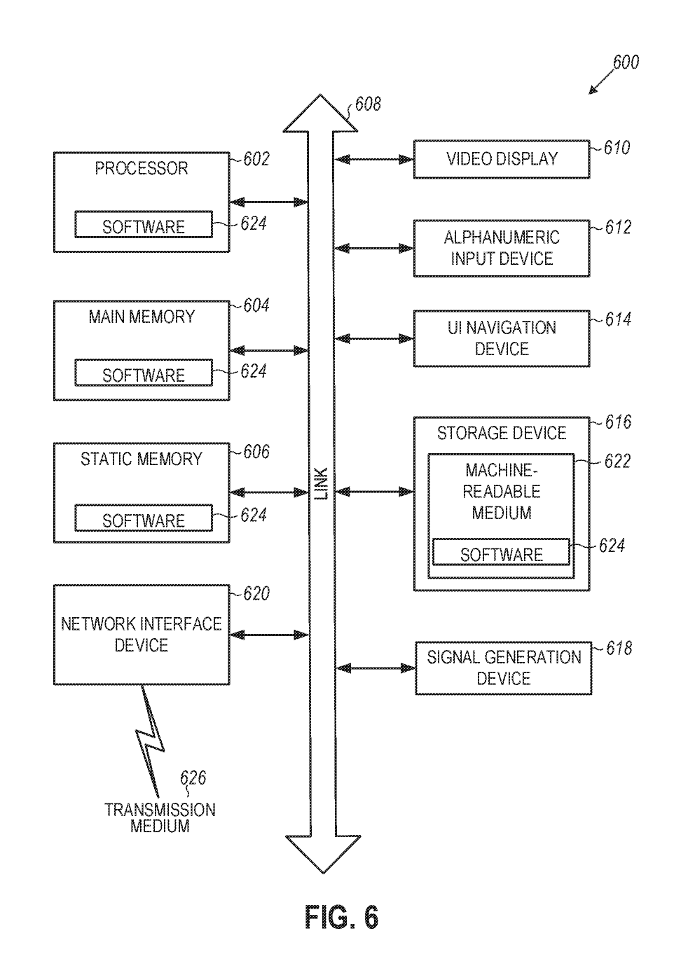

FIG. 6 is an example computing device 600 that may be used in conjunction with the technologies described herein. In alternative embodiments, the computing device 600 may operate as a standalone device or may be connected (e.g., networked) to other computing devices. In a networked deployment, the computing device 600 may operate in the capacity of a server communication device, a client communication device, or both in server-client network environments. In an example, the computing device 600 may act as a peer computing device in peer-to-peer (P2P) (or other distributed) network environment. The computing device 600 may be a personal computer (PC), a tablet PC, a set top box (STB), a personal digital assistant (PDA), a mobile telephone, a smart phone, a web appliance, a network router, switch or bridge, or any computing device capable of executing instructions (sequential or otherwise) that specify actions to be taken by that computing device. Further, while only a single computing device is illustrated, the term “computing device” shall also be taken to include any collection of computing devices that individually or jointly execute a set (or multiple sets) of instructions to perform any one or more of the methodologies discussed herein, such as cloud computing, software as a service (SaaS), other computer cluster configurations.

Computing device 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608. The computing device 600 may further include a display unit 610, an input device 612 (e.g., a keyboard), and a user interface (UI) navigation device 614 (e.g., a mouse). In an example, the display unit 610, input device 612, and UI navigation device 614 may be a touch screen display. In an example, the input device 612 may include a touchscreen, a microphone, a camera (e.g., a panoramic or high-resolution camera), physical keyboard, trackball, or other input devices.

The computing device 600 may additionally include a storage device (e.g., drive unit) 616, a signal generation device 618 (e.g., a speaker, a projection device, or any other type of information output device), a network interface device 620, and one or more sensors 621, such as a global positioning system (GPS) sensor, compass, accelerometer, motion detector, or other sensor. The computing device 600 may include an input/output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.) via one or more input/output ports.

The storage device 616 may include a computing device (or machine) readable medium 622, on which is stored one or more sets of data structures or instructions 624 (e.g., software) embodying or utilized by any one or more of the techniques or functions described herein. In an example, at least a portion of the software may include an operating system and/or one or more applications (or apps) implementing one or more of the functionalities described herein. The instructions 624 may also reside, completely or at least partially, within the main memory 604, within the static memory 606, and/or within the hardware processor 602 during execution thereof by the computing device 600. In an example, one or any combination of the hardware processor 602, the main memory 604, the static memory 606, or the storage device 616 may constitute computing device (or machine) readable media.

While the computing device readable medium 622 is illustrated as a single medium, a “computing device readable medium” or “machine-readable medium” may include a single medium or multiple media (e.g., a centralized or distributed database, and/or associated caches and servers) configured to store the one or more instructions 624.

In an example, a computing device readable medium or machine-readable medium may include any medium that is capable of storing, encoding, or carrying instructions for execution by the computing device 600 and that cause the computing device 600 to perform any one or more of the techniques of the present disclosure, or that is capable of storing, encoding or carrying data structures used by or associated with such instructions. Non-limiting computing device readable medium examples may include solid-state memories, and optical and magnetic media. Specific examples of computing device readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and optical media disks. In some examples, computing device readable media may include non-transitory computing device readable media. In some examples, computing device readable media may include computing device readable media that is not a transitory propagating signal.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.3 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others.

In an example, the network interface device 620 may include one or more physical jacks (e.g., Ethernet, coaxial, or phone jacks) or one or more antennas to connect to the communications network 626. In an example, the network interface device 620 may include one or more wireless modems, such as a Bluetooth modem, a Wi-Fi modem or one or more modems or transceivers operating under any of the communication standards mentioned herein. In an example, the network interface device 620 may include a plurality of antennas to wirelessly communicate using at least one of single-input multiple-output (SIMO), multiple-input multiple-output (MIMO), or multiple-input single-output (MISO) techniques. In some examples, the network interface device 620 may wirelessly communicate using Multiple User MIMO techniques. In an example, a transmission medium may include any intangible medium that is capable of storing, encoding or carrying instructions for execution by the computing device 600, and includes digital or analog communications signals or like communication media to facilitate communication of such software.

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

### Additional Notes and Examples

Example 1 is a system for vehicle-to-vehicle communication, the system comprising: processing circuitry to: receive a data request from a remote vehicle for data not available to the remote vehicle; determine visual data from a host vehicle responsive to the data request that includes, the data not available to the remote vehicle; analyze the visual data for objects to create metadata associated with the visual data; and provide the visual data and the metadata to the remote vehicle in response to the data request.

In Example 2, the subject matter of Example 1 includes, wherein the processing circuitry is further configured to receive the visual data from the host vehicle, the visual data is compressed.

In Example 3, the subject matter of Example 2 includes, wherein the visual data comprises a region of interest (ROI) from a larger image.

In Example 4, the subject matter of Example 3 includes, wherein the visual data comprises a plurality of ROIs from the larger image.

In Example 5, the subject matter of Examples 1-4 includes, wherein the processing circuitry is further configured to: determine available transmission bandwidth to the remote vehicle; reencode the visual data to a lower resolution; and compress the reencoded visual data to create the visual data provided to the remote vehicle.

In Example 6, the subject matter of Examples 1-5 includes, wherein the processing circuitry is further configured to: determine the visual data is not available; determine the host vehicle has access to the visual data; request the visual data from the host vehicle; and receive the visual data from the host vehicle.

In Example 7, the subject matter of Examples 1-6 includes, wherein to determine the visual data the processing circuitry is configured to: receive a location of the remote vehicle; determine a first car located in front of the remote car; and determine a free distance in front of the first car.

In Example 8, the subject matter of Example 7 includes, wherein the processing circuitry is further configured to: determine the free distance is adequate for visual analysis, the visual data comprises data from the first vehicle, and the host vehicle is the first vehicle.

In Example 9, the subject matter of Examples 7-8 includes, wherein the processing circuitry is further configured to: determine the free distance is not adequate for visual analysis; determine a second car in front of the first car; determine a second free distance in front of the second car; and determine the second free distance is adequate for visual analysis, the visual data comprises data from the second vehicle, and the host vehicle is the second vehicle.

In Example 10, the subject matter of Examples 1-9 includes, wherein the processing circuitry is further configured to: receive road condition information, derived from the visual data, from the host car; and provide the road condition information to the remote vehicle.

In Example 11, the subject matter of Examples 1-10 includes, wherein the objects comprise infrastructure objects, traffic lights, and traffic signs.

Example 12 is a machine-implemented method for vehicle-to-vehicle communication, the method comprising: receiving a data request from a remote vehicle for data not available to the remote vehicle; determining visual data from a host vehicle responsive to the data request that includes, the data not available to the remote vehicle; analyzing the visual data for objects to create metadata associated with the visual data; and providing the visual data and the metadata to the remote vehicle in response to the data request.

In Example 13, the subject matter of Example 12 includes, wherein the method further comprises receiving the visual data from the host vehicle, the visual data is compressed.

In Example 14, the subject matter of Example 13 includes, wherein the visual data comprises a region of interest (ROI) from a larger image.

In Example 15, the subject matter of Example 14 includes, wherein the visual data comprises a plurality of ROIs from the larger image.

In Example 16, the subject matter of Examples 12-15 includes, wherein the method further comprises: determining available transmission bandwidth to the remote vehicle; reencoding the visual data to a lower resolution; and compressing the reencoded visual data to create the visual data provided to the remote vehicle.

In Example 17, the subject matter of Examples 12-16 includes, wherein the method further comprises: determining the visual data is not available; determining the host vehicle has access to the visual data; requesting the visual data from the host vehicle; and receiving the visual data from the host vehicle.

In Example 18, the subject matter of Examples 12-17 includes, wherein the determining the visual data comprises: receiving a location of the remote vehicle; determining a first car located in front of the remote car; and determining a free distance in front of the first car.

In Example 19, the subject matter of Example 18 includes, wherein the method further comprises: determining the free distance is adequate for visual analysis, the visual data comprises data from the first vehicle, and the host vehicle is the first vehicle.

In Example 20, the subject matter of Examples 18-19 includes, wherein the method further comprises: determining the free distance is not adequate for visual analysis; determining a second car in front of the first car; determining a second free distance in front of the second car; and determining the second free distance is adequate for visual analysis, the visual data comprises data from the second vehicle, and the host vehicle is the second vehicle.

In Example 21, the subject matter of Examples 12-20 includes, wherein the method further comprises: receiving road condition information, derived from the visual data, from the host car; and providing the road condition information to the remote vehicle.

In Example 22, the subject matter of Examples 12-21 includes, wherein the objects comprise infrastructure objects, traffic lights, and traffic signs.

Example 23 is at least one computer-readable medium comprising instructions which when executed by a machine, cause the machine to perform operations: receiving a data request from a remote vehicle for data not available to the remote vehicle; determining visual data from a host vehicle responsive to the data request that includes, the data not available to the remote vehicle; analyzing the visual data for objects to create metadata associated with the visual data; and providing the visual data and the metadata to the remote vehicle in response to the data request.

In Example 24, the subject matter of Example 23 includes, where wherein the operations further comprise receiving the visual data from the host vehicle, the visual data is compressed.

In Example 25, the subject matter of Example 24 includes, wherein the visual data comprises a region of interest (ROI) from a larger image.

In Example 26, the subject matter of Example 25 includes, wherein the visual data comprises a plurality of ROIs from the larger image.

In Example 27, the subject matter of Examples 23-26 includes, wherein the operations further comprise: determining available transmission bandwidth to the remote vehicle; reencoding the visual data to a lower resolution; and compressing the reencoded visual data to create the visual data provided to the remote vehicle.

In Example 28, the subject matter of Examples 23-27 includes, wherein the operations further comprise: determining the visual data is not available; determining the host vehicle has access to the visual data; requesting the visual data from the host vehicle; and receiving the visual data from the host vehicle.

In Example 29, the subject matter of Examples 23-28 includes, wherein the determining the visual data comprises: receiving a location of the remote vehicle; determining a first car located in front of the remote car; and determining a free distance in front of the first car.

In Example 30, the subject matter of Example 29 includes, wherein the operations further comprise: determining the free distance is adequate for visual analysis, the visual data comprises data from the first vehicle, and the host vehicle is the first vehicle.

In Example 31, the subject matter of Examples 29-30 includes, wherein the operations further comprise: determining the free distance is not adequate for visual analysis; determining a second car in front of the first car; determining a second free distance in front of the second car; and determining the second free distance is adequate for visual analysis, the visual data comprises data from the second vehicle, and the host vehicle is the second vehicle.

In Example 32, the subject matter of Examples 23-31 includes, wherein the operations further comprise: receiving road condition information, derived from the visual data, from the host car; and providing the road condition information to the remote vehicle.

In Example 33, the subject matter of Examples 23-32 includes, wherein the objects comprise infrastructure objects, traffic lights, and traffic signs.

Example 34 is at least one machine-readable medium including instructions that, when executed by processing circuitry, cause the processing circuitry to perform operations to implement of any of Examples 1-33.

Example 35 is an apparatus comprising means to implement of any of Examples 1-33.

Example 36 is a system to implement of any of Examples 1-33.

Example 37 is a method to implement of any of Examples 1-33.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplate are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of“at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The embodiments as described above may be implemented in various hardware configurations that may include a processor for executing instructions that perform the techniques described. Such instructions may be contained in a machine-readable medium such as a suitable storage medium or a memory or other processor-executable medium.

The embodiments as described herein may be implemented in a number of environments such as part of a wireless local area network (WLAN), 3rd Generation Partnership Project (3GPP) Universal Terrestrial Radio Access Network (UTRAN), or Long-Term-Evolution (LTE) or a Long-Term-Evolution (LTE) communication system, although the scope of the disclosure is not limited in this respect. An example LTE system includes a number of mobile stations, defined by the LTE specification as User Equipment (UE), communicating with a base station, defined by the LTE specifications as an eNB.

Antennas referred to herein may comprise one or more directional or omnidirectional antennas, including, for example, dipole antennas, monopole antennas, patch antennas, loop antennas, microstrip antennas or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, antennas may be effectively separated to take advantage of spatial diversity and the different channel characteristics that may result between each of antennas and the antennas of a transmitting station. In some MIMO embodiments, antennas may be separated by up to 1/10 of a wavelength or more.

In some embodiments, a receiver as described herein may be configured to receive signals in accordance with specific communication standards, such as the Institute of Electrical and Electronics Engineers (IEEE) standards including IEEE 802.11 standards and/or proposed specifications for WLANs, although the scope of the disclosure is not limited in this respect as they may also be suitable to transmit and/or receive communications in accordance with other techniques and standards. In some embodiments, the receiver may be configured to receive signals in accordance with the IEEE 802.16-2004, the IEEE 802.16(e) and/or IEEE 802.16(m) standards for wireless metropolitan area networks (WMANs) including variations and evolutions thereof, although the scope of the disclosure is not limited in this respect as they may also be suitable to transmit and/or receive communications in accordance with other techniques and standards. In some embodiments, the receiver may be configured to receive signals in accordance with the Universal Terrestrial Radio Access Network (UTRAN) LTE communication standards. For more information with respect to the IEEE 802.11 and IEEE 802.16 standards, please refer to “IEEE Standards for Information Technology—Telecommunications and Information Exchange between Systems”—Local Area Networks—Specific Requirements—Part 11 “Wireless LAN Medium Access Control (MAC) and Physical Layer (PHY), ISO/IEC 8802-11: 1999”, and Metropolitan Area Networks—Specific Requirements—Part 16: “Air Interface for Fixed Broadband Wireless Access Systems,” May 2005 and related amendments/versions. For more information with respect to UTRAN LTE standards, see the 3rd Generation Partnership Project (3GPP) standards for UTRAN-LTE, including variations and evolutions thereof.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1. A system for vehicle-to-vehicle communication, the system comprising:
processing circuitry to:
receive a data request from a remote vehicle for data not available to the remote vehicle;
determine visual data from a host vehicle responsive to the data request that includes the data not available to the remote vehicle;
analyze the visual data for objects to create metadata associated with the visual data; and
provide the visual data and the metadata to the remote vehicle in response to the data request.

2. The system of claim 1, the processing circuitry is further configured to receive the visual data from the host vehicle, the visual data is compressed.

3. The system of claim 2, the visual data comprises a region of interest (ROI) from a larger image.

4. The system of claim 3, the visual data comprises a plurality of ROIs from the larger image.

5. The system of any of claim 1, the processing circuitry is further configured to:
determine available transmission bandwidth to the remote vehicle;
reencode the visual data to a lower resolution;
compress the reencoded visual data to create the visual data provided to the remote vehicle.

6. The system of claim 1, the processing circuitry is further configured to:
determine the visual data is not available;
determine the host vehicle has access to the visual data;
request the visual data from the host vehicle; and
receive the visual data from the host vehicle.

7. The system of claim 1, to determine the visual data the processing circuitry is configured to:
receive a location of the remote vehicle;
determine a first car located in front of the remote car; and
determine a free distance in front of the first car.

8. The system of claim 7, the processing circuitry is further configured to:
determine the free distance is adequate for visual analysis, the visual data comprises data from the first vehicle, and the host vehicle is the first vehicle.

9. The system of claim 7, the processing circuitry is further configured to:
determine the free distance is not adequate for visual analysis;
determine a second car in front of the first car;
determine a second free distance in front of the second car; and
determine the second free distance is adequate for visual analysis, the visual data comprises data from the second vehicle, and the host vehicle is the second vehicle.

10. The system of claim 1, the processing circuitry is further configured to:
receive road condition information, derived from the visual data, from the host car; and
provide the road condition information to the remote vehicle.

11. The system of claim 1, the objects comprise infrastructure objects, traffic lights, and traffic signs.

12. A machine-implemented method for vehicle-to-vehicle communication, the method comprising:
receiving a data request from a remote vehicle for data not available to the remote vehicle;
determining visual data from a host vehicle responsive to the data request that includes the data not available to the remote vehicle;
analyzing the visual data for objects to create metadata associated with the visual data; and
providing the visual data and the metadata to the remote vehicle in response to the data request.

13. The method of claim 12, wherein the method further comprises receiving the visual data from the host vehicle, the visual data is compressed.

14. The method of claim 13, wherein the visual data comprises a region of interest (ROI) from a larger image.

15. The method of claim 14, wherein the visual data comprises a plurality of ROIs from the larger image.

16. The method of claim 12, wherein the method further comprises:
determining available transmission bandwidth to the remote vehicle;
reencoding the visual data to a lower resolution; and
compressing the reencoded visual data to create the visual data provided to the remote vehicle.

17. The method of claim 12, wherein the method further comprises:
determining the visual data is not available;
determining the host vehicle has access to the visual data;
requesting the visual data from the host vehicle; and
receiving the visual data from the host vehicle.

18. The method of claim 12, wherein the determining the visual data comprises:
receiving a location of the remote vehicle;
determining a first car located in front of the remote car; and
determining a free distance in front of the first car.

19. The method of claim 18, wherein the method further comprises:
determining the free distance is adequate for visual analysis, the visual data comprises data from the first vehicle, and the host vehicle is the first vehicle.

20. The method of claim 18, wherein the method further comprises:
determining the free distance is not adequate for visual analysis;
determining a second car in front of the first car;
determining a second free distance in front of the second car; and
determining the second free distance is adequate for visual analysis, the visual data comprises data from the second vehicle, and the host vehicle is the second vehicle.

21. At least one computer-readable medium comprising instructions which when executed by a machine, cause the machine to perform operations:
receiving a data request from a remote vehicle for data not available to the remote vehicle;
determining visual data from a host vehicle responsive to the data request that includes the data not available to the remote vehicle;
analyzing the visual data for objects to create metadata associated with the visual data; and
providing the visual data and the metadata to the remote vehicle in response to the data request.

22. The at least one computer-readable medium of claim 21, where wherein the operations further comprise receiving the visual data from the host vehicle, the visual data is compressed.

23. The at least one computer-readable medium of claim 22, wherein the visual data comprises a region of interest (ROI) from a larger image.

24. The at least one computer-readable medium of claim 23, wherein the visual data comprises a plurality of ROIs from the larger image.

25. The at least one computer-readable medium of claim 21, wherein the operations further comprise:
determining available transmission bandwidth to the remote vehicle;
reencoding the visual data to a lower resolution; and
compressing the reencoded visual data to create the visual data provided to the remote vehicle.
